(19) United States
(12) Patent Application Publication
(10) Pub. No.: US 2019/0271433 A1
(43) Pub. Date: Sep. 5, 2019

(54) KIT FOR TRANSPORTABLE CONTAINERS

(71) Applicant: G.T. LINE S.R.L., Valsamoggia (IT)

(72) Inventor: Massimo TONELLI, Bologna (IT)

(21) Appl. No.: 16/290,198

(22) Filed: Mar. 1, 2019

(30) Foreign Application Priority Data
Mar. 1, 2018 (IT) 102018000003159

(51) Int. Cl. F16M 11/04; A45C 13/00; A45C 5/03; A45C 5/04

(52) U.S. Cl. CPC F16M 11/04; A45C 13/001; A45C 2005/037; A45C 5/04; A45C 5/03

(57) ABSTRACT

A kit for transportable containers, for the coupling of an external accessory, such as a tripod or the like, to a transportable container; the container includes first and second half-shells which are mutually articulated. The kit includes at least:
a first member which has a head and a threaded pivot, which extends from the head and which can be inserted into a hole which is provided along the first half-shell,
a second member which has a female thread which can be engaged by screwing with the pivot, and
an annular gasket, which can be fitted over the pivot and can be fastened between the head and the first half-shell.

### CROSS REFERENCE TO RELATED APPLICATIONS

This application claims priority to Italian Patent Application No. 102018000003159, filed on Mar. 1, 2018, the contents of which are herein incorporated by reference in their entirety.

### TECHNICAL FIELD

The present disclosure relates to a kit for transportable containers.

### BACKGROUND

In the vast merchandising category of transportable containers, it is possible to find trunks, chests, suitcases, trolley cases, backpacks and other products, which are differentiated by shape, dimensions, materials and/or functionality, as well as by the intended use, the type of goods that can be transported and/or the target market.

Within such category, one segment of major commercial importance is certainly represented by those products that are intended for technicians and professionals in various sectors, who use them to safely transport equipment and instruments necessary for their work.

In more detail, such containers comprise a pair of half-shells which are mutually articulated, made of high-strength rigid (polymeric) material, so as to ensure the ability to withstand impacts, including intensive impacts, without deforming and especially without compromising the integrity of what is accommodated in the internal compartment, which in turn is delimited by the half-shells in a closed configuration.

Furthermore, in order to prevent air, water, humidity or dust from penetrating into the compartment during the transport, damaging the contents thereof, the half-shells and in general the container are provided with gaskets along the edges and various other contrivances, which ensure the hermetic closure.

Occasionally, professional users need to be able to use containers not just to transport equipment and instruments, but also as a raised base on which to support them. To this end, the lower half-shell can be fixed to a tripod, which makes it possible to convert the assembly to a table or pedestal.

For example, the need to rely on a stable pedestal is felt by audio/video operators, and also by people who carry out topographic measurements.

Furthermore, more simply, the configuration just described makes it possible to easily interact with a personal computer, a keypad or any interface located in the container, even in the absence of proper infrastructure, by using the container as a table.

Such implementation solutions are not devoid of drawbacks, however.

It has been seen in fact that one of the principal aims of the container is to ensure the total isolation of the internal compartment during transport or in any case for as long as the half-shells are kept in the closed configuration. When the container is used to transport electronic equipment and instruments, or in any case items that are extremely sensitive, achieving this aim is evidently crucial.

At the same time, it is necessary to be able to couple the tripod to the lower half-shell, stably but at the same time removably on command, thus guarding against the danger of accidental disengagement (with disastrous consequences that are easy to imagine). This is usually achieved by applying reference elements to the outside of the lower half-shell, such as plates, brackets or the like, which are conveniently adapted to be removably engaged with a respective coupling element that is integral with the tripod.

Often however, affixing such reference elements to the half-shell requires making holes in the latter, which risk compromising the hermetic closure capacity completely.

This forces the producer companies to adopt complex contrivances, which are often ineffective or in any case costly and/or not very practical, in order to seek to ensure that the contrasting requirements described above are met.

It should be noted moreover that there are other applications that require the removable coupling of different types of accessories to one of the half-shells, and in these cases too it is possible to encounter the same drawbacks described above for tripods.

### SUMMARY

The aim of the present disclosure is to solve the above mentioned problems, by providing a kit that makes it possible to removably couple a container to an external accessory, be it a tripod or the like, in a practical manner, but without compromising the capacity for hermetically closing and isolating the internal compartment of the container.

Within this aim, the disclosure provides a transportable container that offers practical methods for mating with an external accessory, be it a tripod or the like, but without compromising the capacity for hermetically closing and isolating the internal compartment of the container.

The disclosure also provides a kit and a transportable container wherein the methods for mating with an external accessory are obtained through a solution that is simple and easy to assemble.

The disclosure also provides a kit and a transportable container that ensure a coupling with the external accessory that is stable but at the same time easily removable on command.

The disclosure further provides a kit and a transportable container that ensure a high reliability of operation and/or that adopt an alternative technical and structural architecture to those of conventional solutions.

The disclosure further provides a kit and a transportable container that can be easily provided starting with elements and materials readily available on the market.

The disclosure provides a kit and a transportable container that are low cost and safely applied.

This aim and these and other advantages which will become better apparent hereinafter are achieved by providing a kit according to claim 1 and by a container according to claim 10.

### BRIEF DESCRIPTION OF THE DRAWINGS

Further characteristics and advantages of the disclosure will become better apparent from the description of a preferred, but not exclusive, embodiment of the kit and of the transportable container according to the disclosure, which is illustrated by way of non-limiting example in the accompanying drawings wherein:

FIG. 1 is an exploded perspective view of the kit and the container according to the disclosure;

FIG. 2 is a perspective view from above of the first member of the kit according to the disclosure;

FIG. 3 is a view from above of the first member in FIG. 2;

FIG. 4 is a perspective view from below of the first member in FIG. 2;

FIG. 5 is a perspective view from above of the second member of the kit according to the disclosure;

FIG. 6 is a view from above of the second member in FIG. 5;

FIG. 7 is a perspective view from below of the second member in FIG. 5; and

FIGS. 8 and 9 are side views of two variations of embodiment of an additional component of the kit according to the disclosure.

### DETAILED DESCRIPTION OF THE DRAWINGS

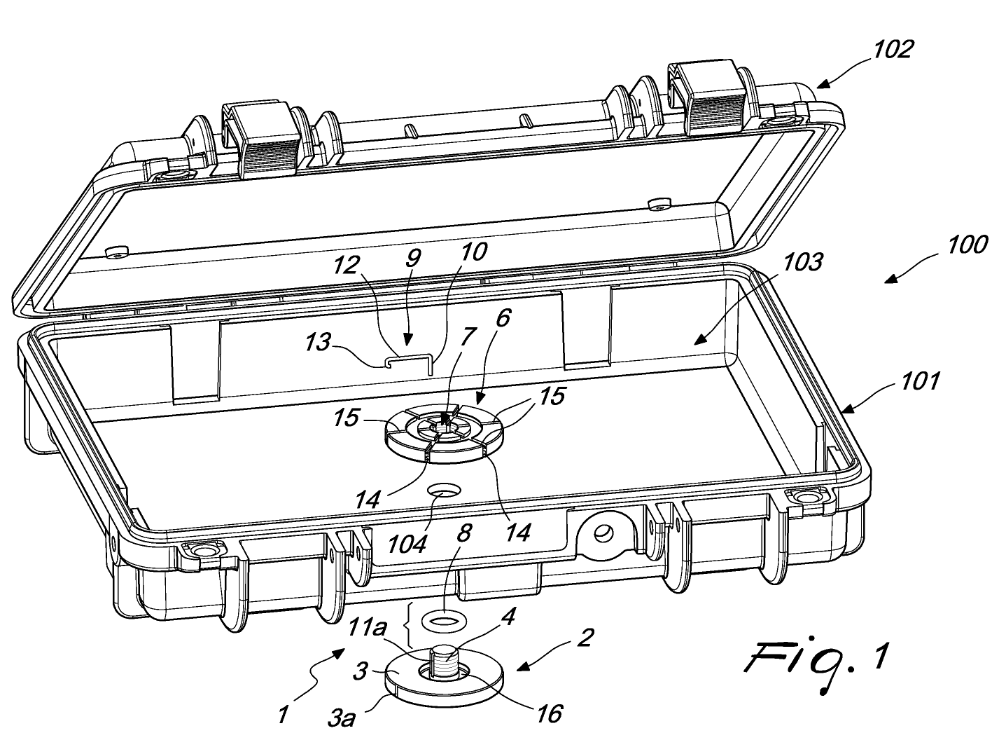

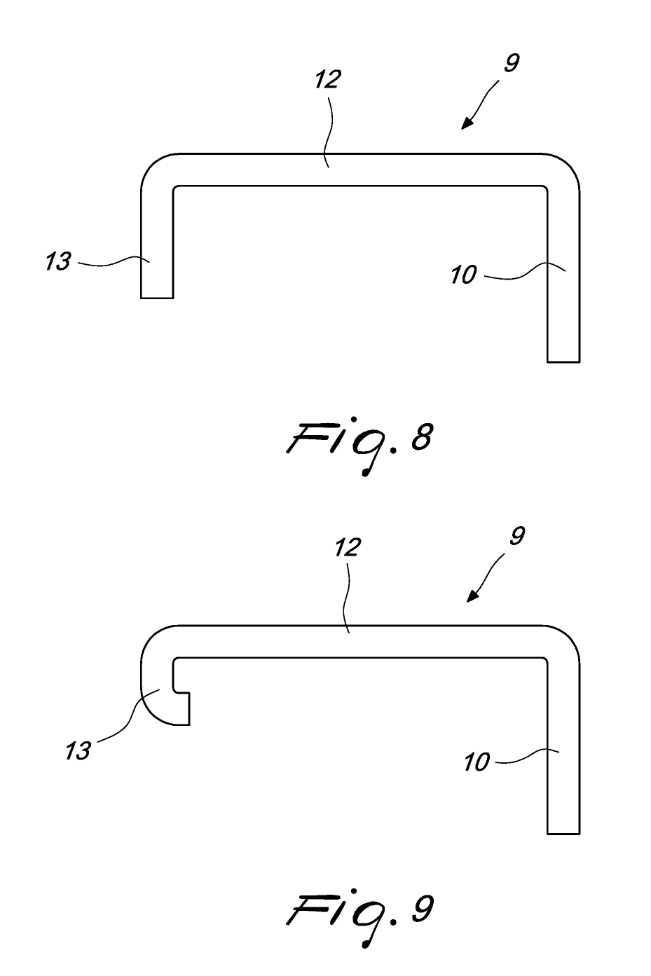

With particular reference to FIGS. 1-9, the reference numeral 1 generally designates a kit for transportable containers 100, of the type of suitcases, chests, trunks, trolley cases and the like.

As will be further repeated below, both the kit 1 and the container 100, which is provided with at least one kit 1, constitute the subject matter of the present discussion and of the protection claimed herein.

In the modes that will be described below, the kit 1 makes it possible to couple an external accessory, of the type of a tripod or the like, to the transportable container 100.

The container 100 comprises a first half-shell 101 and a second half-shell 102 (or lid) which are mutually articulated and can move between at least one configuration for the hermetic closure of an internal compartment 103 and at least one open configuration for free access to the compartment 103 (as for example in FIG. 1).

In any case it should be noted that any reference to containers 100 should be understood as being extended to any type of product (such as indeed a suitcase, a chest, a trunk, a trolley case, or the like) that is capable of accommodating objects, tools, instruments and equipment of various types, both per private use and for professional purposes.

The compartment 103, for example, can therefore contain tools, instruments, equipment, in professional use, and also items of clothing, objects of various types and personal effects, in private use.

Therefore, purely for the purposes of non-limiting example, it should be noted that in the preferred application and in FIG. 1, the container 100, for predominantly professional use, is a form of rigid trunk, made of polymeric material with high resistance to shock.

Furthermore, in order to prevent water, humidity, dust and contaminant agents of any type from penetrating into the compartment 103 (in the closed configuration of the half-shells 101, 102), the container 100 is provided with adapted contrivances, to ensure the completely hermetic closure and tightness of the compartment 103. Such contrivances in any case are conventional and therefore are not discussed in the present text.

The distinction between first half-shell 101 and second half-shell 102 is entirely arbitrary, either of them evidently being capable of being named in each of the two ways.

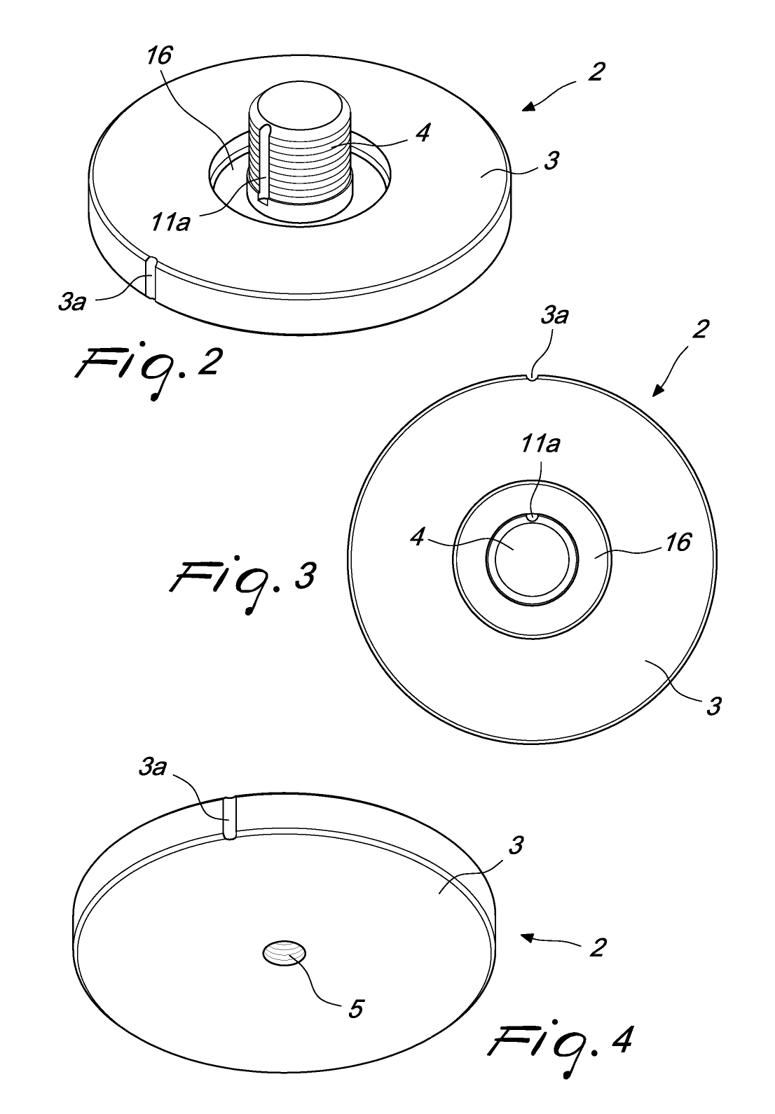

According to the disclosure, the kit 1 comprises at least one first member 2 (visible in FIG. 1 and in more detail in FIGS. 2-4) which has a head 3 and a threaded pivot 4.

The head 3 can be pressed externally (on the opposite side to the compartment 103) against the first half-shell 101 and, according to various methods, it is designed for coupling with the external accessory. For example, the coupling with the external accessory can be obtained by virtue of a threaded orifice 5 (FIG. 4), provided on the opposite side with respect to the pivot 4 (and optionally coaxial with the latter). Thus a screw or the like, which is in any case integral with the tripod or other accessory, can be screwed into the orifice 5. However, the possibility is not ruled out of providing the head 3 with further elements or attachment points, with which to locate and associate the accessory for its removable (or even non-removable) engagement.

The threaded pivot 4 extends from the head 3 and can be inserted into a hole 104 which is provided along the first half-shell 101 (when the head 3 is pressed against the latter).

In the preferred embodiment, and in the accompanying figures, the head 3 has a disk-like shape and the pivot 4 has a cylindrical shape structure, and extends coaxially with respect to the head 3.

However, the possibility is not ruled out of adopting different shape structures for the head 3 and/or the pivot 4, while remaining within the scope of protection claimed herein.

When the accessory is a tripod, it should be noted that the first half-shell 101, with which the first member 2 is associated, is preferably the lower half-shell, intended to be placed on the ground or on a table (in the absence of the tripod) and arranged opposite the half-shell that is moved in order to access or close the compartment 103.

As a function of the application of interest and of the specific type of accessory to be coupled, the first member 2 can in any case be indifferently associated with either one of the two half-shells 101, 102, while remaining within the scope of protection claimed herein.

It is however convenient that the first member 2 (and the head 3 in particular) can be associated with an accessory of any type, while remaining within the scope of protection claimed herein.

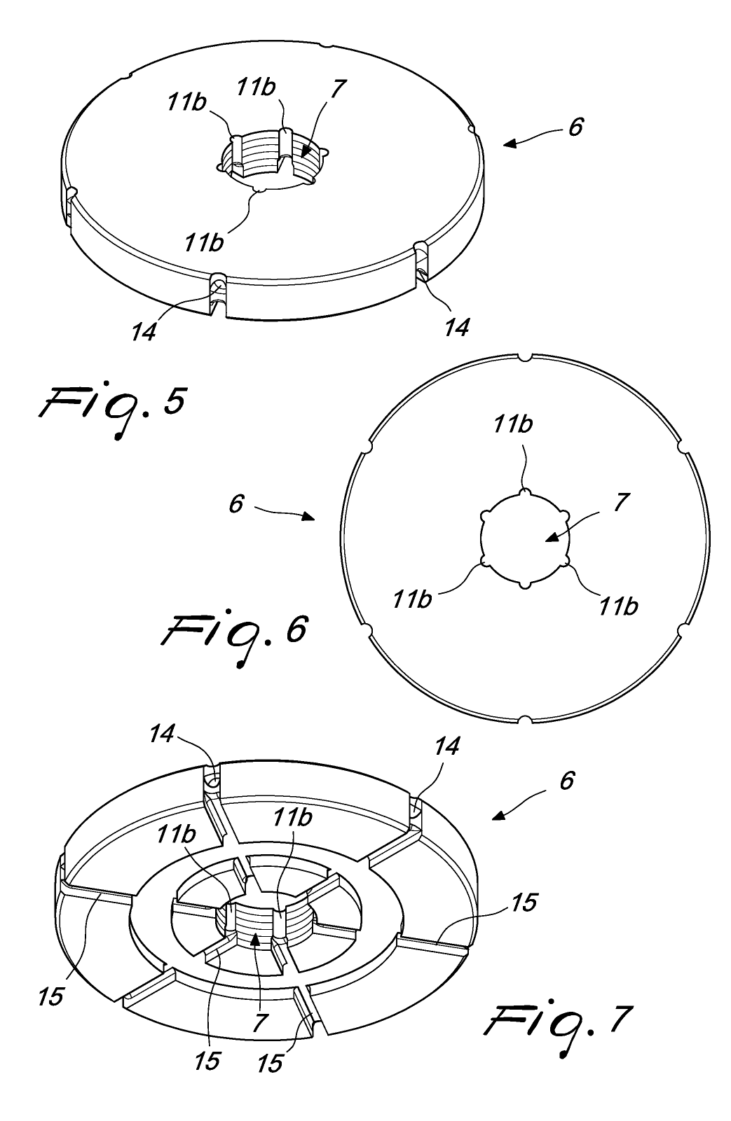

The kit 1 according to the disclosure further comprises at least one second member 6 (visible in FIG. 1 and in more detail in FIGS. 5-7), which can be arranged in the compartment 103 and which has a female thread 7 (a threaded conduit) which can be engaged by screwing with the pivot 4. With the screwing of the pivot 4 into the female thread 7, and having previously inserted the pivot 4 into the hole 104, it is possible to obtain the stable and removable coupling of the first member 2 to the first half-shell 101.

Having reached such condition therefore, it is possible to associate the first member 2 with the accessory of interest in order to also obtain the (removable) coupling of the latter to the first half-shell 101 and therefore to the container 100. In order to subsequently disengage the accessory, it is sufficient to unscrew the second member 6.

In the preferred embodiment, and in the accompanying figures, the second member 6 also has a disk-like shape (similar to that of the head 3), but as with the first member 2, in this case too the possibility is not ruled out of adopting different shape structures, while remaining within the scope of protection claimed herein.

The kit 1 according to the disclosure further comprises at least one annular gasket 8 (FIG. 1); it can be an O-ring or the like. The annular gasket 8 can be fitted over the pivot 4, being fastened between the head 3 and the first half-shell 101, when the pivot 4 is inserted into the hole 104 and screwed into the female thread 7. This makes it possible to obtain hermetic coupling between the first member 2 and the first half-shell 101.

In order to increase the efficacy of isolation and hermetic closure, the kit 1 will in any case be provided with an additional O-ring or other auxiliary gasket, to be fitted over the pivot 4 from inside the compartment 103, and intended therefore to be clamped between the first half-shell 101 and the second member 6.

Conveniently, the kit 1 according to the disclosure comprises a safety element 9 (visible in FIG. 1 and in more detail, in two different variations of embodiment, in FIGS. 8 and 9), which can be removably arranged so as to interfere with the rotation of the second member 6 with respect to the first member 2, after the pivot 4 has been screwed into the female thread 7. In this manner, the element 9 can effectively oppose the counter-rotation of the second member 6 with respect to the first member 2 and therefore obstruct accidental unscrewing.

This is found to be of undoubted interest first of all in order to prevent vibrations, wear and tear or damage (such as to determine an imperfect behavior of the threading of the pivot 4 or of the female thread 7) could bring about an unwanted gradual extraction. Furthermore, the safety element 9 can effectively oppose any counter-rotation that might otherwise occur when a screw or another component integral with the tripod or other accessory is screwed into the orifice 5.

In particular, in the embodiment illustrated in the accompanying figures by way of non-limiting example of the application of the disclosure, the safety element 9 comprises an arm 10 which can be inserted into a channel of corresponding shape and dimensions.

Such channel is defined (delimited) by two slots 11a, 11b which are brought into mutual alignment following the screwing of the pivot 4 into the female thread 7 up to a respective angular setting.

More precisely, a first slot 11a is axially provided along the pivot 4, while a second slot 11b is axially provided along the female thread 7. With the progressive screwing of the pivot 4 into the female thread 7, the first slot 11a rotates until it reaches the condition of alignment with the second slot 11b at a specific angular setting,

and then evidently replicates the same condition after each complete rotation (each time an angle of 360° is traversed).

In the condition of alignment (and only in such condition) the two slots 11a, 11b delimit a channel into which can be inserted the arm 10, which is thus situated between the threadings and prevents any subsequent rotation (in any direction).

Evidently, to ensure the obstruction to rotation, the slots 11a, 11b must be chosen to be of shape and dimensions that are such as to delimit, once aligned, a channel that has the same shape and the same dimensions of the arm 10.

More specifically, and as in the solution in the accompanying figures, the female thread 7 has a plurality of second axial slots 11b which are mutually parallel, each one of which is able to be aligned with the first slot 11a at a respective angular setting of the second member 6 with respect to the first member 2, in order to define the channel.

In this manner, it is possible to obtain several conditions for alignment, from which the user can choose the one that he or she deems best adapted for the arm 10 to be inserted into the channel thus formed. The choice in this sense can thus fall on the specific angular setting in which the user deems that the screwing of the pivot 4 into the female thread 7 is complete, having sufficiently clamped the first half-shell 101 between the members 2, 6.

Advantageously, the head 3 is provided externally with a reference notch 3a, which is aligned with the first slot 11a. In the accompanying figures, the notch 3a is obtained with a form of axial incision carried out along the outer edge, but it should be made clear that a simple band of a different color, or another reference mark, can be used, while remaining within the scope of protection claimed herein. In any case, when the pivot 4 is inserted into the hole 104 of the first half-shell 101 and is screwed into the female thread 7, and therefore the first slot 11a is not visible, the notch 3a ensures the user an easier identification of the condition of alignment between the first slot 11a and the second slot(s) 11b. The alignment of the notch 3a with a second slot 11b, in fact, also corresponds to the alignment of the latter with the first slot 11a.

With further reference to the embodiments provided in the accompanying figures, which are shown for the purposes of non-limiting example of the disclosure, the safety element 9 is constituted by a rod which is substantially bent in a U-shape. In this manner, the rod defines a first end segment, which constitutes the arm 10, a central segment 12, which is perpendicular to the first portion (and adjacent thereto), and a second end segment 13.

In the embodiment in FIG. 8, the second end segment 13 is straight in shape, and is simply parallel to the arm 10. Conversely, in the embodiment in FIG. 9 (and in FIG. 1), the second end segment 13 is bent further so as to form a hook which can engage the second member 6 (in order to guard against the danger of accidental disengagement of the element 9 from the second member 6).

Even more specifically, and with further reference to the embodiment in FIGS. 1 and 9, the second member 6 comprises at least one respective recess 14, which is provided along its external lateral surface and is aligned with a corresponding second slot 11b, in order to elastically accommodate therein the (hook-shaped) second end segment 13 and guard against the danger of accidental disengagement of the safety element 9. Preferably, each second slot 11b corresponds to a respective recess 14.

In an embodiment of significant practical interest, which in any case does not limit the application of the disclosure, the second member 6 has a flattened shape (preferably disk-like as has been seen) and has, on one of its bases, a plurality of radial grooves 15 (continuous or interrupted in a central region, as in the accompanying figures).

The radial grooves 15 are aligned with respective second slots 11b (preferably in number equal to the latter), in order to accommodate the central segment 12 of the rod when the arm 10 is inserted into the channel.

Conveniently, the head 3 has an annular groove 16, which is provided around the base of the pivot 4, for accommodating at least partially the annular gasket 8 (in particular, when the latter is interposed and clamped between the head 3 and the first half-shell 101).

As already anticipated, as well as the kit 1, the present disclosure also relates to a transportable container 100, of the type of suitcases, chests, trunks, trolley cases and the like.

According to various shapes, dimensions, materials and intended uses, such container 100 comprises a first half-shell 101 and a second half-shell 102 (a lid) which are mutually articulated and can move between at least one configuration for the hermetic closure of an internal compartment 103 and at least one open configuration for free access to the compartment 103.

According to the disclosure, the transportable container 100 comprises at least one kit 1 with the specifications given in the foregoing paragraphs (and therefore, at least, a first member 2, a second member 6 and an annular gasket 8), in order to provide the coupling (hermetic and removable) of an external accessory, of the type of a tripod or the like.

The protection claimed herein is understood to be extended to include the kit 1 sold individually and/or together with the accessory, and also to the container 100 sold together with the kit 1 (and optionally provided with at least one accessory).

When it is intended to use the tripod, or in any case to use an accessory such as a pedestal or supporting base, the container 100 can further be provided with additional useful elements.

For example, the container 100 can be supplied with a light shade (which can be accommodated in the compartment 103 or in a section of the latter, during the transport of the container 100). When it is desired to interact with the instruments and equipment present in the container 100, for example when the latter is supported on the tripod, the shade can be extracted from the container 100 and optionally fixed in various ways to one of the two half-shells 101, 102, so as to offer shade from the sun's rays.

The container 100 can likewise comprise a tray (which can also be accommodated in the compartment 103 or in a subdivision of the latter, during the transport of the container 100), which is optionally provided with flip-up containment sidewalls (and/or, on the other side, with fold-out supporting feet), which can be extracted as needed from the compartment 103 to be taken away from the container 100 carrying the instruments of interest (or some thereof).

Use of the kit according to the disclosure is the following.

As has been seen, the kit 1 makes it possible to removably couple the container 100 to a tripod or to another external accessory.

In order to obtain such result, after having fitted the annular gasket 8 over the pivot 4, the user can first of all press the head 3 of the first member 2 against the first half-shell 101 (against an outer surface thereof, and preferably against the bottom), taking care to insert the pivot 4 into the hole 104 (which indeed is preferably provided on the bottom of the first half-shell 101). By virtue of an adapted dimensioning, the pivot 4 protrudes into the compartment 103, so as to permit the subsequent screwing into the female thread 7 of the second member 6, until the clamping is obtained of the annular gasket 8 and in general the stable, hermetic coupling is obtained of the members 2, 6 to the first half-shell 101 and to the container 100.

By virtue of the orifice 5 or other attachment point, the first member 2 can therefore be associated with and coupled to a tripod or any other external accessory, thus obtaining in fact the coupling between the latter and the container 100, in a practical manner. Such coupling can subsequently be removed in a likewise easy manner by decoupling the external accessory from the first member 2 or by unscrewing the pivot 4 from the female thread 7.

The presence of the annular gasket 8 ensures the tightness of the coupling (the hermetic closure and/or isolation of the compartment 103), preventing any penetration or passing through of substances at the hole 104, which is necessary in order to couple the members 2, 6 to the first half-shell 101.

It should be noted that preferably the user will obtain the screwing by keeping the first member 2 fixed and making the second member 6 rotate, but the possibility is not ruled out obviously of the opposite solution.

In any case, the simple steps described above show that by virtue of the use of the kit 1 the coupling of the accessory (and the subsequent decoupling, if any) is obtained by way of a solution that is simple and easy to assemble.

When the user deems that the desired clamping force has been obtained, he or she can use the safety element 9 to prevent subsequent unseating or in any case any mutual movement between the members 2, 6. It is in fact sufficient to stop the screwing upon the alignment of the first slot 11a with a slot 11b, in order to allow the insertion of the arm 10 into the channel delimited by the slots 11a, 11b, thus obtaining interference with the rotation.

The element 9 therefore ensures an even more stable coupling, but one that is at the same time easily removable on command.

The disclosure thus conceived is susceptible of numerous modifications and variations, all of which are within the scope of the appended claims. Moreover, all the details may be substituted by other, technically equivalent elements.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

1. A kit for transportable containers, for the coupling of an external accessory to a transportable container, and comprising a first half-shell and a second half-shell which are mutually articulated and can move between at least one configuration for an hermetic closure of an internal compartment and at least one open configuration for free access to the compartment, further comprising at least:
a first member which has a head that can be pressed externally against the first half-shell and is designed for coupling to the external accessory, and a threaded pivot, which extends from said head and can be inserted into a hole which is provided along the first half-shell,
a second member which can be arranged in the compartment and has a female thread which can be engaged by screwing with said pivot, for a stable and removable coupling of said first member to the first half-shell, and
an annular gasket, which can be fitted over said pivot and can be fastened between said head and the first half-shell, when said pivot is inserted into the hole and screwed into said female thread, for hermetic coupling between said first member and the first half-shell.

2. The kit according to claim 1, further comprising a safety element, which can be arranged removably so as to interfere with a rotation of said second member with respect to said first member, following a screwing of said pivot into said female thread, in order to hinder accidental unscrewing.

3. The kit according to claim 2, wherein said safety element comprises an arm which can be inserted into a channel having corresponding shape and dimensions, which is defined by two slots which can be mutually aligned as a consequence of the screwing of said pivot into said female thread up to a respective angular setting, a first said slot being provided axially along said pivot and a second said slot being provided axially along said female thread.

4. The kit according to claim 3, wherein said female thread has a plurality of said second slots which are mutually parallel, each one of said second slots being able to be aligned with said first slot at a respective angular setting of said second member with respect to said first member, in order to define said channel.

5. The kit according to claim 3, wherein said head is provided externally with a reference notch, which is aligned with said first slot, configured to identify the condition of alignment between said first slot and said second slot, when said pivot is inserted into the hole of the first half-shell and screwed into said female thread.

6. The kit according to claim 4, wherein said safety element is constituted by a rod which is substantially bent in a U-shape, for the definition of a first end segment, which constitutes said arm, of a central segment, which is perpendicular to said first segment, and of a second end segment, which is bent further so as to form a hook which can engage said second member.

7. The kit according to claim 6, wherein said second member comprises at least one respective recess, which is provided along an external lateral surface of said second member and is aligned with a corresponding said second slot, for the elastic accommodation of said second end segment.

8. The kit according to claim 6, wherein said second member has a flattened shape and has, on a base, a plurality of radial grooves, which are aligned with respective said second slots, for the accommodation of said central segment of said rod when said arm is inserted into said channel.

9. The kit according to claim 1, wherein said head has an annular groove, which is provided along a base of said pivot, for the at least partial accommodation of said annular gasket.

10. A transportable container comprising: a first half-shell and a second half-shell which are mutually articulated and can move between at least one configuration for the hermetic closure of an internal compartment and at least one open configuration for free access to said compartment, further comprising a kit for the coupling of an external accessory according to claim 1.
